(19) United States
(12) Patent Application Publication
(10) Pub. No.: US 2006/0130598 A1
(43) Pub. Date: Jun. 22, 2006

(54) Method and apparatus for collecting evidence

(76) Inventor: Cory Van Driessche, Calexico, CA (US)

Correspondence Address: VIERA CONSULTING, Post Office Box 13596, La Jolla, CA, 92039, US

(21) Appl. No.: 11/022,536

(22) Filed: Dec. 22, 2004

(51) Int. Cl. G01N 1/04

(52) U.S. Cl. 73/864.71

(57) ABSTRACT

An improved method and apparatus for collecting evidence at a scene of an investigation is disclosed. In one embodiment, an improved apparatus for collecting trace evidence is disclosed. The improved evidence collecting apparatus generally comprises a handle, a roller, and a wound collecting element, wherein the wound collecting element is wound about the roller. An investigator at a scene of an investigation can roll the roller over a particular area of concern and lift trace evidence onto the wound collecting element.

### BACKGROUND

1. Field of the Invention

This invention generally relates to methods and apparatuses for collecting evidence at a scene of an investigation, particularly for collecting trace evidence.

2. Related Art

Collection of evidence from a scene of an investigation presents several challenges. Law enforcement authorities often desire to collect certain quantities of evidence from a scene of a crime, such as for example a rape, kidnapping, burglary, arson or a murder scene. In many cases, there are small quantities of “trace” evidence, that may be uncollected by current solutions. Examples of “trace” evidence includes small quantities of blood, hair, semen, tears, sweat, or any other small piece of evidence left by a perpetrator and/or accomplice. An investigation leaving incriminating trace evidence behind can, in some cases, effectively preclude a conviction, or in other cases, preclude even procuring a suspect.

Previously proposed solutions for collecting trace evidence have utilized, inter alia, “evidence tape” to “lift” such evidence from a crime scene investigation, such as for example from a carpet or bed sheets. Such solutions have an adhesive side to the “evidence tape”, which function to adhere to trace evidence that have been left behind by the perpetrator. The evidence tape is then transported to a crime laboratory, whereat the evidence tape is immersed in a solution, such as for example water or methanol, to separate the trace evidence from the tape. A drawback of such solutions is a potential to denature, deform, cross-contaminate, or otherwise compromise the trace evidence collected from the scene of the investigation, when the evidence tape is immersed in the solution.

In some previously proposed solutions, a three inch by five inch (“3×5”) adhesive card is used to collect trace evidence. In using this solution, law enforcement officers “lift” trace evidence by repeatedly applying the 3×5 card to an area they suspect evidence may have been left by a perpetrator or accomplice, until no adhesive remains. A drawback of this solution is that there is no traceable way to recreate precisely where the trace evidence was found, as it will effectively have been “layered” onto the 3×5 card, because of the repeated application of the 3×5 card to the scene of the crime. In some cases, it may be necessary to precisely recreate exactly where a piece of trace evidence was found in order to recreate events.

Another commonly known issue arising from the collection of such evidence derives from a potential contamination of the collected evidence. Contamination of evidence collected at the scene of an investigation can cause such evidence to be inadmissible at trial. Although solutions for collecting and preserving the integrity of the evidence have evolved, there is still a need in the industry to provide improved methods and apparatuses for improved means to collect and preserve evidence integrity for forensic analysis and evidentiary usage in a potential conviction of a perpetrator.

Moreover, packaging, transportation, and storage of collected evidence also create a potential for the evidence acquired at a crime scene to be contaminated, altered, destroyed, or otherwise compromised. Such compromised evidence can ultimately lead to an acquittal of an otherwise guilty criminal, such as for example a rapist or murderer.

Not only is a better solution needed to address the aforementioned issues with criminal scene investigations, but there are also instances when civil disputes may call for an investigation, calling for collection of trace evidence.

Hence, a need exists to provide improved methods and apparatuses for the collection of trace evidence, which will minimize risk of cross-contamination while simultaneously maximizing the potential to lift trace evidence from a scene of an investigation, which might otherwise be missed.

### SUMMARY

An improved apparatus for the collection of evidence is disclosed. The improved evidence collection apparatus is adapted to collect a quantity of evidence at a scene of an investigation, wherein the scene of the investigation has a particular area of concern. The improved apparatus generally comprises a longitudinal shaft element, a roller member, and a wound collecting element. The longitudinal shaft element has first and second end portions, which share a common longitudinal axis. The first end portion has a handle element attached thereto, and the second end portion has a connector member connected thereto. A roller member is pivotally connected to the connector member, and the roller member rotates about a circumferential axis of rotation. A wound collecting element, which has a plurality of windings, is operatively connected to the roller member. The wound collecting element has a first side, which has an adhesive material affixed thereto. The wound collecting element has a second side having a non-adhesive affixed thereto.

An improved apparatus for collecting and preserving evidence from a scene of an investigation is also disclosed. In one embodiment, adhesive tape is adapted to collect a quantity of trace evidence from a particular area of concern at the scene of an investigation. In this embodiment, the apparatus also comprises a sheath, which is adapted to enclose the adhesive tape, after the adhesive tape has been used to collect potential trace evidence.

A method of collecting and preserving evidence from a scene of an investigation is disclosed. In one embodiment, the method comprises identifying an area of particular concern at a scene of an investigation from which trace evidence is sought, preparing at least a first rolling tape collecting means, rolling the tape collecting means over the particular area of concern, unwinding a length of the rolling tape collecting means, collecting trace evidence, providing a sheath means, opening a first receiving end of the sheath means, inserting the rolling tape inside the sheath means, enclosing the rolling tape inside the sheath means.

### BRIEF DESCRIPTION OF THE DRAWINGS

Embodiments of the present invention will be more readily understood by reference to the following figures, in which like reference numbers and designations indicate like elements.

FIG. 1A illustrates a perspective view of an embodiment of an improved evidence collecting apparatus.

FIG. 1B illustrates a roller member of the improved evidence collecting apparatus.

FIG. 1C illustrates a cross sectional view of the roller member with a circumferential axis of rotation.

FIGS. 1D-1H illustrate a cross sectional view of an unwinding action of a roller member having a wound collecting element operatively connected to the roller member.

FIG. 2A illustrates a front view of a sheath for preserving collected evidence integrity.

FIG. 2B illustrates a front view of the collected evidence being placed into the sheath, corresponding to FIG. 2A.

FIG. 2C illustrates the collected evidence inside the sheath, corresponding to FIGS. 2A and 2B.

FIG. 3 illustrates an improved method for collecting evidence at a scene of an investigation.

### DETAILED DESCRIPTION

An improved evidence collecting apparatus is disclosed in the present teachings. The improved collecting apparatus is adapted to collect a quantity of investigatory evidence at a scene of an investigation. In one embodiment, a context within which the improved evidence collecting apparatus is employed is when there is a particular area of concern at the scene of the investigation. It will be appreciated that the scene of investigation is not limited to criminal investigatory scenes, but could also be used to collect evidence at civil investigatory scenes, or any other scene from which trace evidence must be collected.

As used herein, the term “trace evidence” refers to relatively small pieces of evidence left at a particular area of concern, at the scene of an investigation. Examples of trace evidence comprise, inter alia, blood, hair, semen, tears, sweat, or any other small piece of evidence. Examples of a particular area of concern will vary depending upon the context of the investigation and the reasons for which the investigation is conducted. Some contextual examples where the present teachings may be used are bed sheets in a rape case, an area around a murder scene, or a place of a kidnapping.

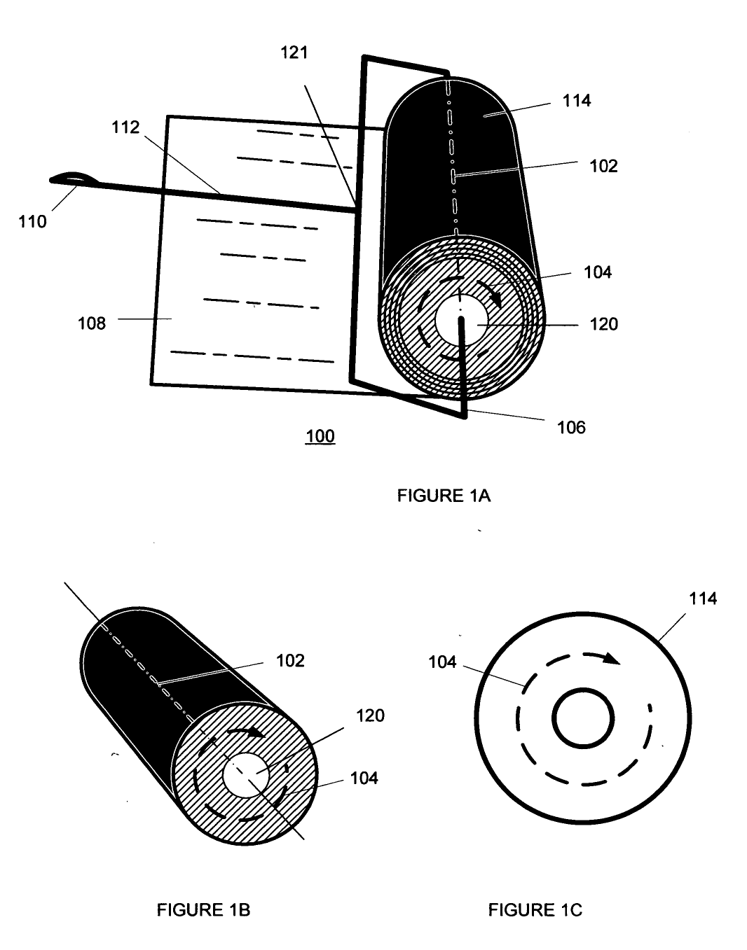

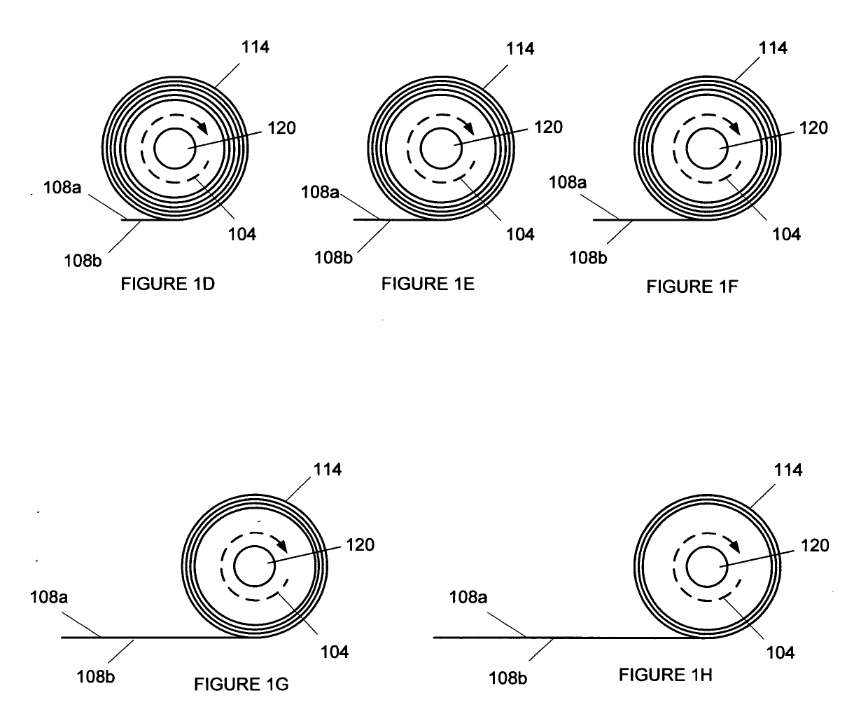

Referring now to FIG. 1A, a perspective drawing of one embodiment of an improved evidence collecting apparatus 100 is illustrated. In this embodiment, a longitudinal shaft element 112 is pivotally connected to a roller member 120. The roller member 120 is operatively connected to a wound collecting element 114.

In one embodiment, the longitudinal shaft element 112 has a first end portion 110 and a second end portion 121, which share a common longitudinal axis. The first end portion 110 of the longitudinal shaft element 112 has a handle element connected thereto. The second end portion 121 of the longitudinal shaft element 112 has a connector member connected thereto.

A roller member 120 is pivotally connected to the connector member connected to the second end portion 121 of longitudinal shaft element 112. The roller member 120 connected to the connector member is pivotally connected to the connector member, in the sense that the roller member 120 has a circumferential axis of rotation 104, about which the roller member 120 is designed to pivot (rotate) around. The roller member 120 also has a longitudinal axis 102, along which the roller member 120 is approximately cylindrically constant. In some embodiments, the roller member 120 is composed of plastic, steel, wood, rubber, and/or metal alloy.

Wound collecting element 114 is wound about the roller member 120, as shown in FIG. 1A. The wound collecting element 114 shares the roller member 120 longitudinal axis 102. FIG. 1A shows an unwinding action of the wound collecting element 114.

FIG. 1B illustrates the roller member 120 and respective axis. As shown in FIG. 1B, the roller member 120 has a circumferential axis of rotation 104, a longitudinal axis 102.

FIG. 1C illustrates a cross sectional view of roller member 120, illustrating a circumferential axis of rotation 104.

Referring now to FIG. 1D-FIG. 1H, an unwinding action of wound collecting element 114 is illustrated. Wound collecting element 114 is wound around roller member 120 concentrically. As the roller member 120 rotates about the circumferential axis 104, a portion of wound collecting element 114 unwinds from the roller member 120. The portion of wound collecting element 114 that is unwound in this process is laid approximately flat across the particular area of concern at the scene of the investigation.

Wound collecting element 114 has a first side 108b and a second side 108a. In one embodiment, an adhesive material is affixed to the first side 108b of wound collecting element 114, which is adapted to adhere to trace evidence in the particular area of concern at the scene of the investigation. The second side 108a, of the wound collecting element 114, is a non-adhesive material. However, in some embodiments, the second side 108a is an adhesive material.

In some embodiments, the wound collecting element 114 is approximately transparent. Similarly, the adhesive material on the first side 108b, of the wound collecting element 114, is in some embodiments, approximately transparent. In these embodiments, the function of the transparent aspect of the wound collecting element 114 and the adhesive material is to provide investigators the ability to view trace evidence directly though the material from which element 114 and the adhesive material are composed.

One advantage of the present teachings is that by rolling the improved apparatus over a particular area of concern at the scene of the investigation, fingerprints or other contaminates that an investigator might inadvertently place on the collecting tape is minimized or entirely precluded from occurring, as the unwinding element 114 precludes the investigator from needing to touch the tape for purposes of collecting trace evidence.

In one exemplary embodiment, the wound collecting element 114 has a width of 8.5 inches and a length of 10 inches; however, it will be appreciated that any width or length of element 114 may be used, depending upon the particular of concern at the scene of the investigation, from which evidence is sought to be collected. In some embodiments, a plurality of wound collecting elements 114 are concatenated together and wound about the roller member 120.

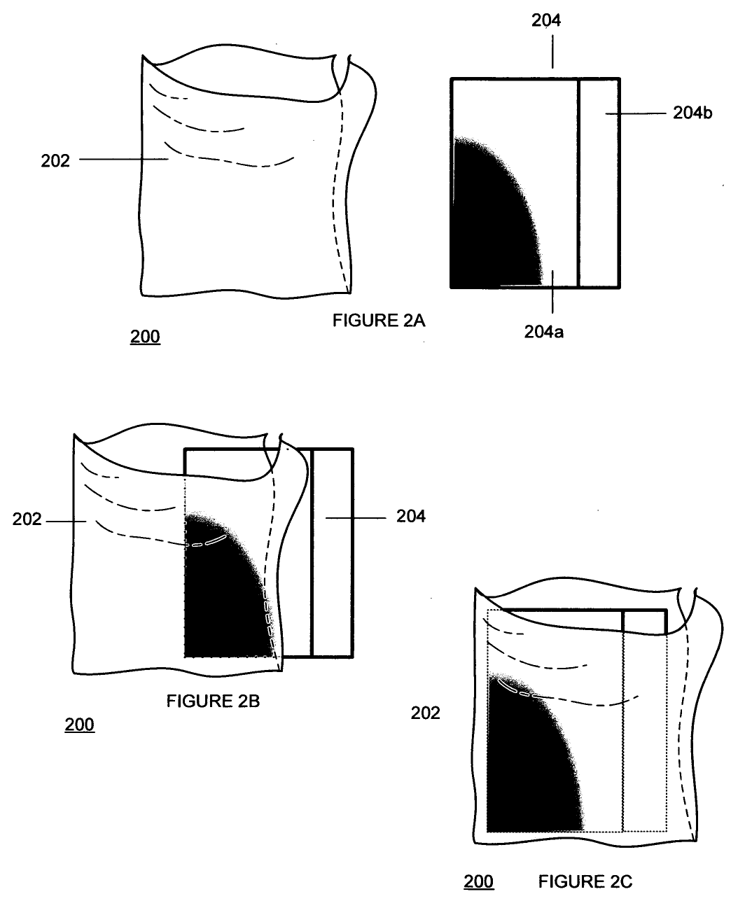

Referring now to FIG. 2, in one embodiment, an apparatus 200 for collecting and preserving evidence from a scene of an investigation is disclosed. In this embodiment, an adhesive tape 204 is adapted to collect a quantity of trace evidence from a particular area of concern at a scene of an investigation. The adhesive tape 204 has a main body portion 204a and an additional body portion 204b. The main body portion 204a is the portion of the tape 204, wherein a quantity of trace evidence has been collected thereon, as described above. The additional body portion 204b functions to provide an area for labeling the tape 204. In one embodiment, an investigator may label the additional body portion 204b with markings that correspond to a specific area within the particular area of concern, to facilitate reconstruction of events for the purposes of investigation. Also, the additional body portion 204b provides investigators with a safe place to handle the trace evidence collected, without touching the area in which the trace evidence was collected in the main body portion 204a.

Apparatus 200 for collecting and preserving evidence from a scene of an investigation also has a sheath 202 associated therewith. In one embodiment, the sheath 202 is a transparent material within which the adhesive tape 204 is inserted. In this embodiment, the sheath is transparent and adapted to allow an investigator to circle, mark, label, or otherwise notate remarks corresponding an area from which the tape was “rolled”, and/or correspond to a particular piece of trace evidence collected.

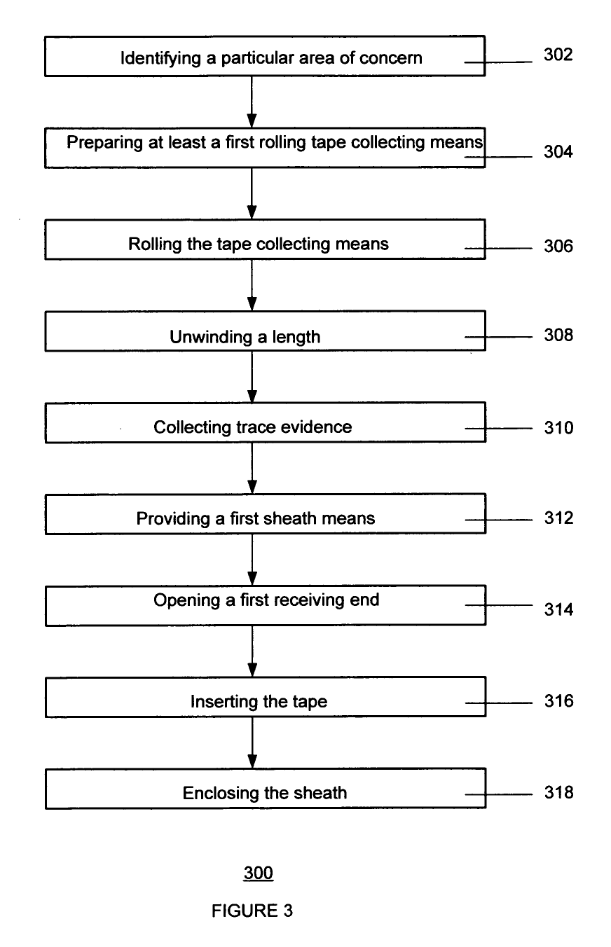

Referring now to FIG. 3, a method 300 for collecting and preserving evidence is disclosed. The method 300 begins with a STEP 302 of identifying a particular area of concern within a scene of an investigation, wherefrom trace evidence is sought to be collected. The method 300 continues with a STEP 304 of preparing at least a first rolling tape collecting means. In preparing the rolling tape collecting means, at least one wound collecting element, as described above, is wound about a roller tape collecting means. In some variations of the method 300, a plurality of roller tape collecting means are concatenated together.

The next STEP 306, is to roll the rolling tape collecting means over at least a portion of the particular area of concern by rolling the tape collecting means about an axis of rotation. As the tape collecting means rolls about the axis of rotation, a length of the rolling tape collecting means unwinds, STEP 308, and is laid approximately flat upon the particular area of concern at the scene of the investigation. In the next STEP 310, by unwinding the rolling tape collecting means, the rolling tape is collecting trace evidence in the particular area of concern.

The next STEP 312 of the method 300 is providing a first sheath means, which has a receiving end for receiving the rolling tape collecting means. By opening, STEP 314, the first receiving end of the sheath means wide enough for the rolling tape collecting means, the method 300 proceeds to a STEP 316 of inserting the rolling tape collecting means inside the sheath means. The next STEP 318 is enclosing the sheath means to protect the rolling tape collecting means from contamination or mishandling. The sheath means may be marked on or otherwise labeled by investigators, without fearing contamination of the trace evidence.

In some embodiments, the method 300 proceeds to a step of photographing the area from which the trace evidence was “lifted”, and labeling the sheath means with information corresponding to the specifically photographed area. Using this embodiment of the present teachings allows investigators to reconstruct a particular scene of an investigation, by being able to precisely pinpoint where, and in what orientation, the trace evidence was found at the scene.

The foregoing description illustrates exemplary implementations, and novel features, of aspects of a method and apparatus for collecting evidence, such as may be employed in a crime scene investigation. Alternative implementations are suggested, but it is impractical to list all alternative implementations of the method and apparatus. Therefore, the scope of the presented invention should be determined only by reference to the appended claims, and should not be limited by features illustrated in the foregoing description except insofar as such limitation is recited in an appended claim.

While the above description has pointed out novel features of the invention as applied to various embodiments, the skilled person will understand that various omissions, permutations, substitutions, and changes in the form and details of the methods and systems illustrated may be made without departing from the scope of the invention.

Each practical and novel combination of the elements and alternatives described hereinabove, and each practical combination of equivalents to such elements, is contemplated as an embodiment of the invention. Because many more element combinations are contemplated as embodiments of the invention than can reasonably be explicitly enumerated herein, the scope of the invention is properly defined by the appended claims rather than by the foregoing description. All variations coming within the meaning and range of equivalency of the various claim elements are embraced within the scope of the corresponding claim. Each claim set forth below is intended to encompass any apparatus or method that differs only insubstantially from the literal language of such claim, as long as such apparatus or method is not, in fact, an embodiment of the prior art. To this end, each described element in each claim should be construed as broadly as possible, and moreover should be understood to encompass any equivalent to such element insofar as possible without also encompassing the prior art. Furthermore, to the extent that the term “includes” is used in either the detailed description or the claims, such term is intended to be inclusive in a manner similar to the term “comprising.”

What is claimed is:

1. An improved evidence collecting apparatus, adapted for collecting a quantity of evidence at a scene of an investigation, wherein the scene of the investigation has a particular area of concern, comprising:
a) a longitudinal shaft element, having a first end portion and a second end portion sharing a common longitudinal axis, wherein the first end portion has a handle element and the second end portion has a connector member connected thereto;
b) a roller member, pivotally connected to the connector member, wherein the roller member rotates about a circumferential axis of rotation;
c) a wound collecting element, operatively connected to the roller member, comprising:
i) a first side and a second side, wherein the wound collecting element has a plurality of windings concentrically wound about the roller member in a circumferential fashion;
ii) an adhesive material affixed to the first side of the collecting element, wherein the adhesive material is adapted to adhere to evidence, and;
iii) a non-adhesive material affixed to the second side of the collecting member.

2. The improved evidence collecting apparatus as recited in claim 1, wherein the adhesive material is transparent.

3. The improved evidence collecting apparatus as recited in claim 2, wherein the collecting element has a width 8.5 inches and a length of 10 inches.

4. The improved evidence collecting apparatus as recited in claim 3, wherein the roller member is adapted to mount a plurality of collecting elements thereon the roller member.

5. The improved evidence collecting apparatus as recited in claim 1, wherein the roller member is composed of a material, or composite of materials, selected from the group consisting essentially of: plastic, steel, wood, rubber and/or metal alloy.

6. An apparatus for collecting and preserving evidence from a scene of an investigation, wherein a quantity of trace evidence is sought to be collected from a particular area of concern at the scene of the investigation, comprising:
a) an adhesive tape, adapted to collect a quantity of trace evidence from a particular area of concern at the scene of an investigation, wherein the adhesive tape has a main body portion and an additional body portion, and;
b) a sheath, adapted to enclose the adhesive tape when the adhesive tape has been used to collect trace evidence.

7. A method of collecting and preserving evidence from a scene of an investigation, wherein a quantity of trace evidence is sought to be collected from a particular area of concern at the scene of the investigation, comprising the steps of:
a) identifying an area at the scene of an investigation as a particular area of concern from which trace evidence is sought;
b) preparing at least a first rolling tape collecting means;
c) rolling the at least a first rolling tape collecting means about an axis of rotation, prepared in step b), over the particular area of concern identified in step a);
d) unwinding a length of the at least a first rolling tape collecting means;
e) collecting trace evidence in the particular area of concern at the scene of the investigation;
f) providing a first sheath means, having a first receiving end for receiving the at least a first rolling tape collecting means;
g) opening the first receiving end of the first sheath means wide enough for the at least a first rolling tape collecting means;
h) inserting the at least a first rolling tape collecting means inside the first sheath means, and;
i) enclosing the at least a first rolling tape collecting means inside the first sheath means.

8. The method of collecting and preserving evidence, as recited in claim 7, wherein the method further comprises, the step:
i) photographing the particular area of concern at the scene of the investigation, and;
j) labeling the first sheath means with information corresponding to a specific photographed location within the particular area of concern from which trace evidence is sought to be extracted.

9. The method of collecting and preserving evidence, as recited in claim 7, further comprising the step of labeling the first sheath means with information corresponding to a specific location within the particular area of concern from which trace evidence is sought to be extracted.
